(19) United States
(12) Patent Application Publication
(10) Pub. No.: US 2019/0263197 A1
(43) Pub. Date: Aug. 29, 2019

(54) Tire Inflation System Visual Flow Indicator

(71) Applicant: Equalaire Systems, Inc., Corpus Christi, TX (US)

(72) Inventor: James Sharkey, San Antonio, TX (US)

(73) Assignee: Equalaire Systems, Inc., Corpus Christi, TX (US)

(21) Appl. No.: 16/343,702

(22) PCT Filed: Oct. 20, 2017
(86) PCT No.: PCT/US17/57643

§ 371 Date: Apr. 19, 2019

Related U.S. Application Data
(60) Provisional application No. 62/410,765, filed on Oct. 20, 2016.

(51) Int. Cl. B60C 23/04; B60C 23/00

(52) U.S. Cl. CPC B60C 23/0406; B60C 23/007; B60C 23/003

(57) ABSTRACT

A visual flow indicator provided on a tire inflation system air hose or rotary union housing.

### CROSS-REFERENCE TO RELATED APPLICATION

This application claims priority to U.S. Provisional Patent Application No. 62/410,765 entitled “Tire Inflation System Visual Flow Indicator” filed Oct. 20, 2016.

### FIELD

This application relates generally to vehicle tire inflation.

### BACKGROUND

Automatic tire inflation systems may be used to maintain vehicle tire pressure by adding air to the vehicle's tires without need for a human operator to inflate the tires from an air pressure source external to the vehicle, such as a maintenance shop air supply. When a leak occurs, an operator must inspect all tires of the vehicle to determine which tire in the system requires attention. The current methods of attempting to identify the leak through audible and tactile indicators is inexact and time consuming.

Thus, there exists a need for a device that allows the operator and/or technician to identify the tire that is leaking with speed and accuracy.

### BRIEF DESCRIPTION OF THE DRAWINGS

FIG. 1 illustrates an embodiment of a vehicle having a plurality of inflation manifolds mounted thereto.

FIG. 2 illustrates an embodiment of an inflation system with flow indicators installed.

FIG. 3 illustrates a flow indicator incorporated into a rotary union.

FIG. 4 illustrates a flow indicator based on an observable turbine.

FIG. 5 illustrates a flow indicator based on disturbable pellets.

FIG. 6 illustrates a flow indicator based on a lighted indicator.

FIG. 7 illustrates a flow indicator based on a flow meter.

### DETAILED DESCRIPTION

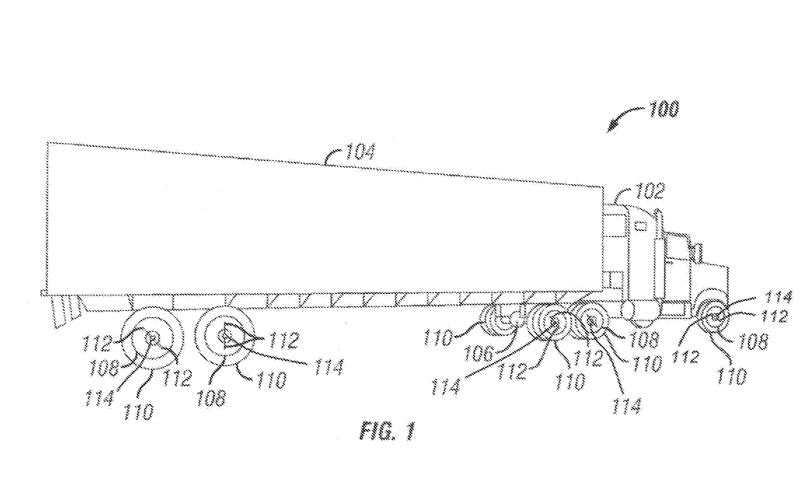

As may be seen in FIG. 1, a vehicle 100 may comprise any vehicle having dual tires, such as semi-trucks, heavy-duty pickup trucks, RVs, dump trucks, and class 7 and 8 trailers to name a few. In the embodiment of FIG. 1, the vehicle may comprise a truck 102 and a trailer 104. The truck 102 may include one or more drive axles 106 as part of the truck's powertrain. The truck 102 may further include a steer axle having pivotable spindles that may provide steering capability for the vehicle 100. The trailer 104 may include one or more fixed axles. Each trailer and truck axle may have single or dual wheels 108 mounted at each end. Steer axles may have a single wheel 108. A pneumatic tire 110 may be mounted to each wheel 108.

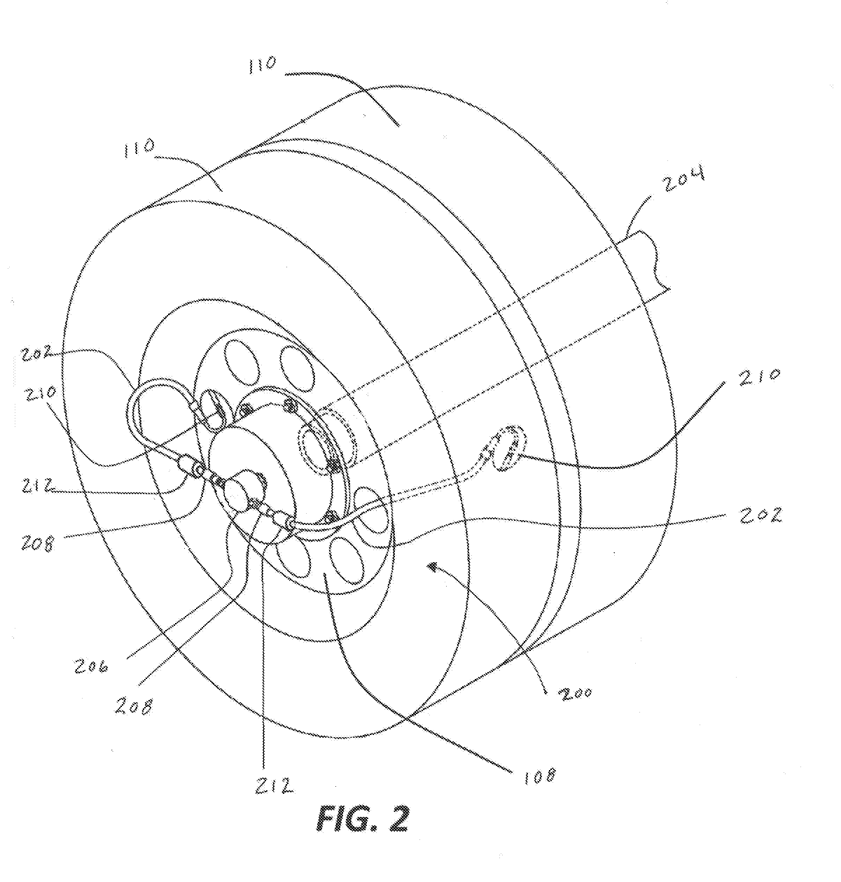

As may be seen in FIG. 2, an inflation system 200 may be installed at the wheel end. The inflation system 200 may include air hose 202, rotary union 206, a hose fitting 208, tire valve stems 210, and flow indicators 212 as appropriate. Pressurized fluid may be delivered from a pressure source on the vehicle to the rotary union through the axle 204 or an air line external to the wheel end.

As seen in FIG. 2, the sight flow indicator 212 may be a visual aid provided in fluid communication between the rotary union 206 and the tire valve 210 of the inflation system. A flow indicator 212 may be located in series with any of the other fluid-conveying components of the inflation system 200. In some embodiments, the flow indicator 212 may be located near to the center of rotation of the inflation system, such as near the rotary union. Such location may serve to reduce additional centripetal forces and moments generated by the added mass of the flow indicator 212. In other embodiments, the location of the flow indicator 212 may be at any point between the rotary union and the tire valve. In some embodiments, a flow indicator may be part of the rotary union housing. The flow indicator 212 may be a separate component in the system or be an integral part of the air hose 202. The flow indicator 212 may give a visual alert of which tire 110 on the vehicle is leaking.

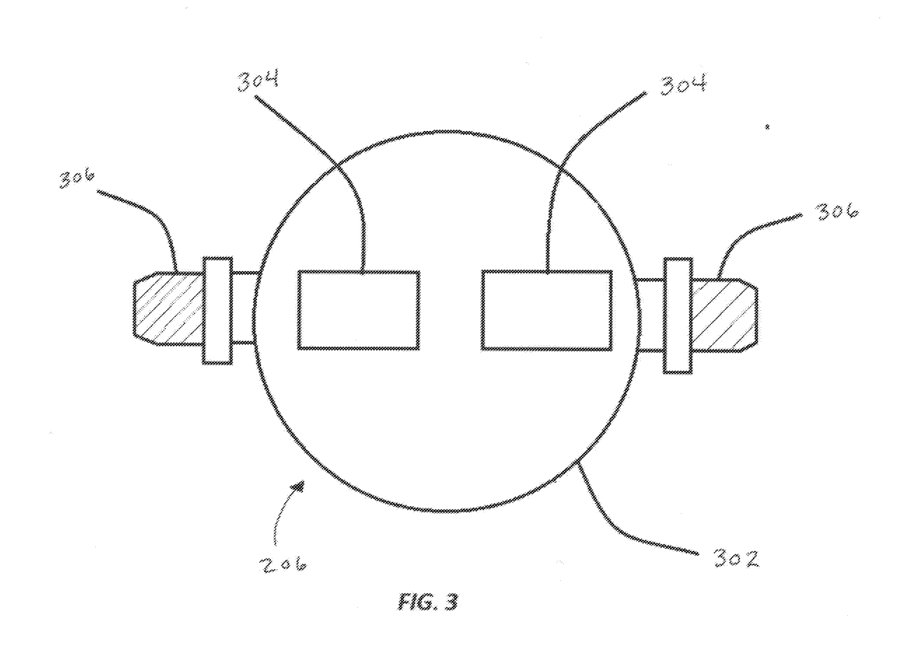

As can be seen in FIG. 3, a flow indicator 304 may be located at a central point on the axis of wheel rotation, such as at the rotary union. A flow indicator 304 may be located in the rotary union next to each of the ports 306. As pressurized fluid flows in the rotary union 302 and out through a port 306 to a corresponding tire via air hose, the visual indicator may indicate fluid flow. For rotary unions provided inside a hubcap, or integrated into a hub cap, one or more visual indicators may be disposed on or built into the hubcap so that air passing through fluid channels in the hubcap may activate the flow indicator. For example, a visual indicator may be made visible through the sight glass of a rotary union hubcap.

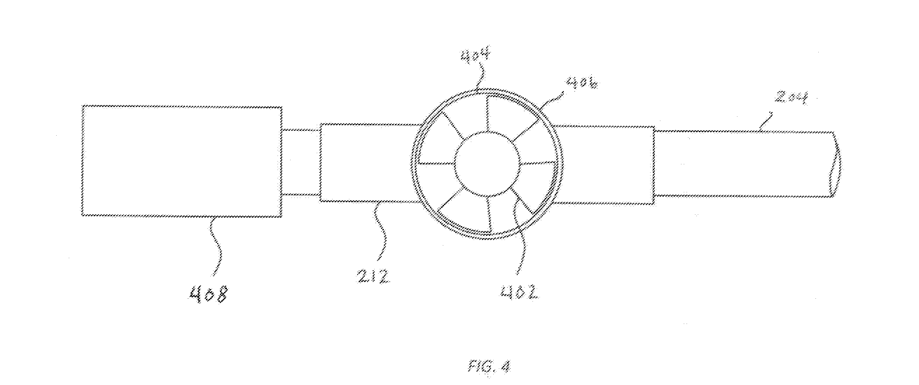

As seen in FIG. 4, the visual alert mechanism of the flow indicator 212 may comprise a turbine 402 that actuates when exposed to a fluid flow and may be observed through an observation window 404 in the flow indicator body 406. The paddle rotor or turbine 402 may employ different colors on alternating blades to facilitate ease in discerning a flow indication. The flow indicator 212 may be located inline with or part of an air hose 204, and may be disposed adjacent a hose connection 408.

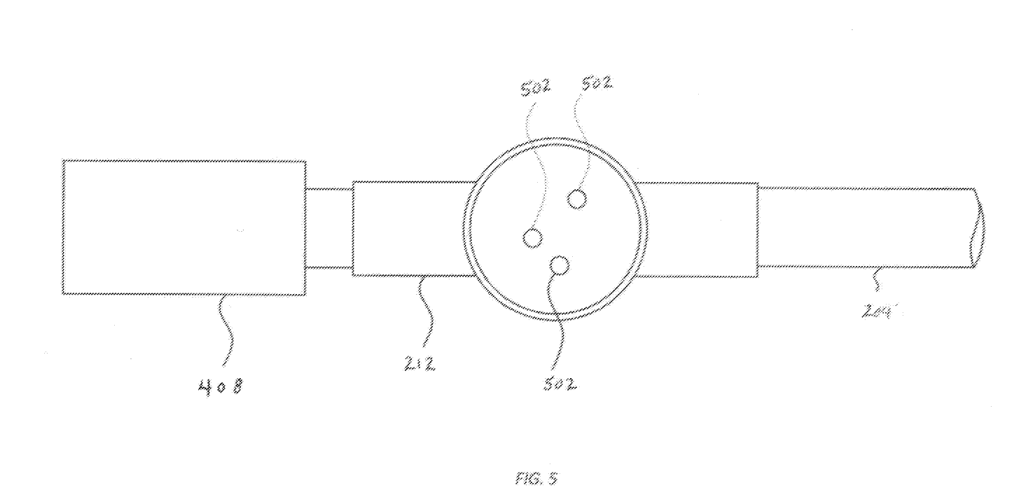

As seen in FIG. 5, other visual alert mechanisms for the flow indicator 212 may rely on pellets 502 of any suitable material, such as plastic or low density metals, that are agitated in the presence of a fluid flow. These pellets may be of a color that draws attention to the pellets 502 when they are agitated. These pellets 502 may range in number from a single pellet 502 to a plurality of pellets 502 in a single indicator. Other agitatable objects may be used, as well, such as ribbons, sliding or lifting cylinders or balls, and confetti.

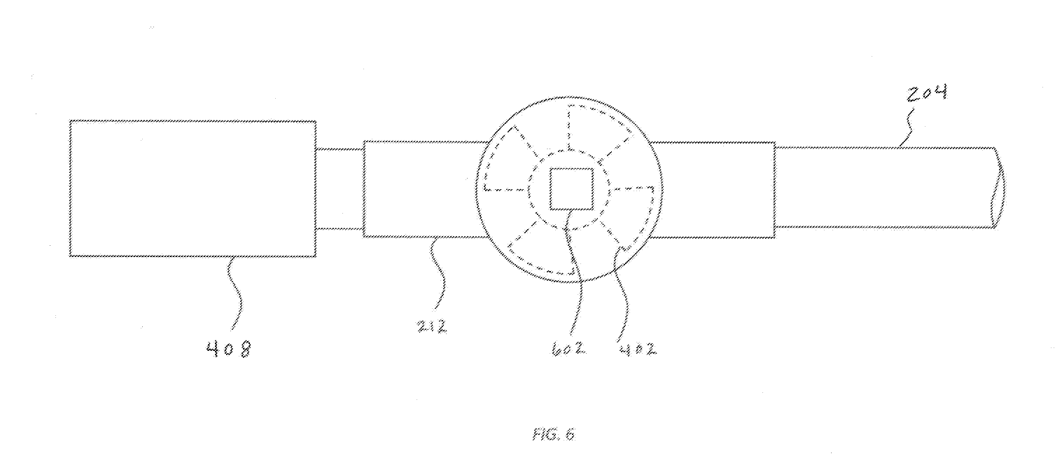

As can be seen in FIG. 6, a lighted indicator 602 that is activated when a fluid flow is present in the indicator body may be provided. These indicator mechanisms may also be used in combination, such as but not limited to, a fluid-flow-powered turbine 402 connected to an electrical generator that may provide the power signal for an external lighted indicator 602. An energy storage device, such as a battery or capacitor, may store electrical energy from the generator so that the light may remain illuminated after the turbine stops turning. The indicator may include a reset button that allows an operator to turn off the light after checking the tire.

In other embodiments, a flow switch may activate the lighted indicator. A flow switch may be of any suitable type, such as a paddle switch, a thermal flow sensor, a shuttle or piston switch, or a piezo flow switch. A turbine generator, or solar power source, or battery or other suitable power source may be used to provide power. Use of a switch that indicates flow at a specific flow rate may provide an indication of the severity of a tire leak. In some embodiments, the lighted indicator may be statefully controlled so as to indicate the tire to which fluid has flowed even if the flow has stopped (such as when the tire inflation system has shut off).

In other embodiments, an electronic display may be used in place of or in addition to the lighted indicator. Various flow data, such as flow rate, flow start time, flow stop time, direction of flow, and flow log may be displayed for an operator. Any visual indication method for the inline and in series flow indicator 212 may be appropriate for a centrally located flow indicator 212 such as may be located in the through tee 206.

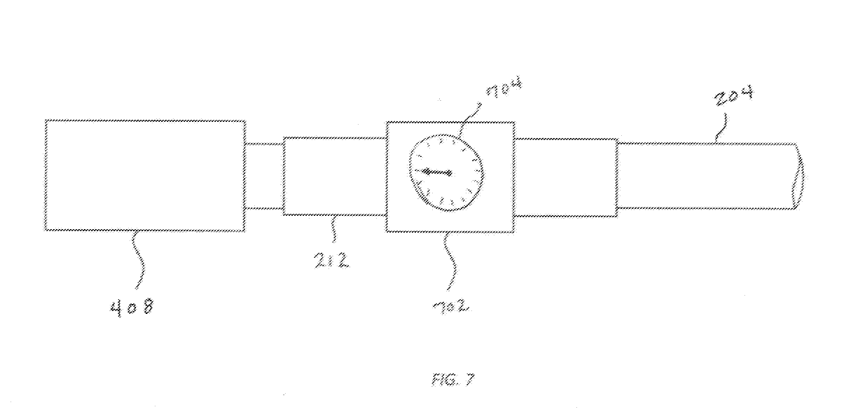

As can be seen in FIG. 7, the flow indicator 212 may utilize a flow meter 702 indicating positive displacement, differential pressure, velocity, mass or other applicable measurement variables. The flow meter 702 may indicate the scalar quantity of air flow in the inflation system 200. The flow meter 702 may indicate flow through a gauge 704 of either an analog or digital nature. This gauge 704 may convey measurement data through analog display or through a digital nature. A flow indicator 212 of such a nature may allow the operator to gauge the magnitude and nature of any leak the inflation system may be attempting to overcome for the tire in question.

Although the disclosed subject matter and its advantages have been described made herein without departing from the invention as defined by the appended claims. Moreover, the scope of the present application is not intended to be limited to the particular embodiments of the process, machine, manufacture, composition, or matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. For example, although the disclosed apparatus, systems and methods may be described with reference to a manual or manually-activated pressure reduction valve, an electric valve or other automatic electronic or mechanical valve may be used to accomplish relatively rapid reduction of air pressure. Accordingly, the appended claims are intended to include within their scope such processes, machines, manufacture, compositions of matter, means, methods, systems or steps.

I claim:

1. A tire inflation system comprising:
a source of pressurized fluid;
a pneumatic tire having a valve stem configured to receive pressurized fluid;
a rotary air connection in sealed fluid communication between the source of pressurized fluid and the pneumatic tire; and
a visual flow indicator disposed in a path of sealed fluid communication between the rotary air connection and the pneumatic tire.

2. The system of claim 1, the rotary air connection comprising the visual flow indicator.

3. The system of claim 1, further comprising an air hose forming the path of sealed fluid communication, the air hose having a first end in sealed connection with the rotary air connection and a second end in sealed connection with the valve stem, the visual flow indicator being disposed either between the rotary air connection and the first end of the air hose, or between the valve stem and the second end of the valve stem.

4. The system of claim 1, further comprising an air hose forming the path of sealed fluid communication, the air hose comprising the visual flow indicator.

5. The system of claim 1, the visual flow indicator comprising at least one of a visually-observable turbine, a light activatable by a turbine generator, a flow meter, a light activatable by a flow switch, a digital display coupled to a flow switch, and a plurality of agitatable beads.

6. The system of claim 1, the rotary air connection comprising a hubcap having an integrated rotary union.

7. The system of claim 1, the rotary air connection comprising a hubcap having a rotary union disposed therein.

8. An air hose configured to convey pressurized air from a rotary air connection to a pneumatic tire, the air hose comprising a visual flow indicator.

9. The air hose of claim 8, the visual flow indicator comprising at least one of a visually-observable turbine, a light activatable by a turbine generator, a flow meter, a light activatable by a flow switch, a digital display coupled to a flow switch, and a plurality of agitatable beads.

10. A hubcap having an air hose port, and fluid channel configured to convey pressurized air from a rotary connection to the air hose port, the hubcap having a visual flow indicator disposed so as to detect fluid flow in the fluid channel.

11. The hubcap of claim 10, the visual flow indicator comprising at least one of a visually-observable turbine, a light activatable by a turbine generator, a flow meter, a light activatable by a flow switch, a digital display coupled to a flow switch, and a plurality of agitatable beads.
